(19) United States
(12) Patent Application Publication
(10) Pub. No.: US 2005/0127099 A1
(43) Pub. Date: Jun. 16, 2005

(54) Electric multi-reservoir liquid soap dispenser

(76) Inventor: Kuei Tang Chou, Ping Chen City (TW)

Correspondence Address: Kuei Tang Chou, PO Box 82-144, Taipei, TW

(21) Appl. No.: 10/735,782

(22) Filed: Dec. 16, 2003

(51) Int. Cl. B67D 5/52

(52) U.S. Cl. 222/135

(57) ABSTRACT

An electric multi-reservoir liquid soap dispenser comprises a coupling base, at least two reservoirs and a control circuit. Each reservoir includes a containing space for containing liquid soap. The containing space has an ease-open cover on the top, a downward liquid outlet at the bottom, and couplers beneath and on the edge of the containing space for coupling to a backboard interiorly provided with a control circuit. After assembly of the reservoir is completed, the coupling base can be fastened to an appropriate position on the wall, and the at least two reservoirs can be coupled with the coupling base. By way of the detection of the control circuit, whether or not each reservoir respectively releases detergent can be correctly determined.

### BACKGROUND OF THE INVENTION

(a) Technical Field of the Invention

The present invention relates to an electric multi-reservoir liquid soap dispenser and the accompanied circuit, particular to a liquid soap dispenser, which can contain at least two reservoirs of detergent. When a user stretches out under any one of the reservoirs, the chosen reservoir will positively release the required liquid soap, while the un-chosen reservoir would not. The invention is applicable to public places where require a liquid soap dispenser of greater content or the like.

(b) Description of the Prior Art

To maintain personal hygiene, the rest rooms of the public places used to provide with detergent for people to wash hands. The most common liquid soap dispenser is a single-reservoir dispenser fixed to the wall. The user can press the button on the housing to release the liquid soap for use.

Further, in view of the improved technology, liquid soap dispensers become electric type as disclosed in R.O.C. publication No. 360515 entitled “Automatic Liquid Soap Dispenser”, which comprises:
a liquid soap supplier;
a motor driving pump connected to the liquid soap supplier via of piping; a liquid soap releasing device connected to the motor driving pump via piping; and
an electric circuit for actuating the pump driving motor, which includes:
   a sensor for detecting to determine if the user's hand has arrived the right position for receiving the liquid soap released from the liquid soap dispenser;
   a control circuit for the advancing motor connected to the sensor and the pump driving motor for responding to an actuating signal received the sensor, in order to drive the motor along the advancing direction, such that the liquid soap can be transmitted to the releasing device;
   a liquid soap quantity regulating/controlling circuit which is connected to the advancing motor control circuit and the sensor, such that after a pre-determined period of time subsequent to receipt of an actuating signal from the sensor, the advancing motor control circuit will send out a pause signal; and
   a reversing motor connected to the pump driving motor and the liquid soap quantity regulating/controlling circuit for responding to a pause signal received from the liquid soap quantity regulating/controlling circuit, in order to drive the motor along the reverse direction, such that the liquid soap current would become a backflow.

The above-mentioned prior art has improved the defect that the user must press the dispensing button manually to obtain the liquid soap, which is rather inconvenient. However, given that a number of electric liquid soap dispensers are arranged in a line, the respective sensor might be led to a misjudgment when the user's hand inadvertently and suddenly passes the underside of the sensor, and thus allow the liquid soap to release in error. As a result, the liquid soap released for nothing would be wasted, the washroom floor could be polluted thereby, and in turn, the user is possibly exposed to the danger of slip.

In view of the above defects existing in the prior art, the present invention has provided a structure that can correctly judge the right time for releasing the liquid soap without any error, as claimed by the inventor.

### SUMMARY OF THE INVENTION

The primary object of the present invention is to provide an electric multi-reservoir liquid soap dispenser, which may permit combination of at least two reservoirs in a liquid soap dispenser and correct determination on whether or not the chosen dispensing device does operate, while the un-chosen dispensing device would not take an error operation.

To obtain the above object, the present invention comprises a coupling base, at least two reservoirs and a control circuit. Each reservoir includes a containing space for containing liquid soap. The containing space has an ease-open cover on the top, a tube downwardly extending from the bottom, and couplers provided beneath and on the back. The coupler beneath and back of the containing space connected to a lower base for holding the control circuit, while the extruding edge is provided on the periphery of the coupling base such that when the coupling base is coupled with the reservoir, there will be sufficient carrying capacity. By way of the detection of the control circuit, whether or not each reservoir respectively releases detergent can be correctly determined.

Many other advantages and features of the present invention will become manifest to those versed in the art upon making reference to the detailed description and the accompanying sheets of drawings in which a preferred structural embodiment incorporating the principles of the present invention is shown by way of illustrative example.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is bottom view of the present invention.

FIG. 3 is an exploded view of the present invention.

FIG. 4 is an exploded view of the reservoir according to the invention.

FIG. 5 is a cut-away view taking from 5-5 in FIG. 1.

FIG. 6 is a cut-away view taking from 6-6 in FIG. 1.

FIG. 7 is a detailed circuitry of the invention.

FIG. 8 is another detailed circuitry of the invention.

FIG. 9 is flow chart showing the operation of the invention.

### DETAILED DESCRIPTIONS OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

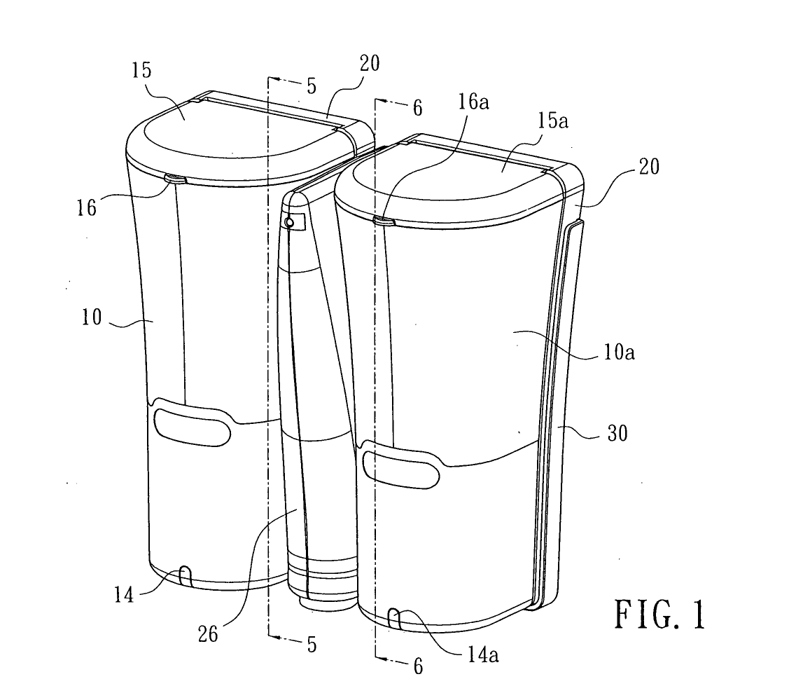

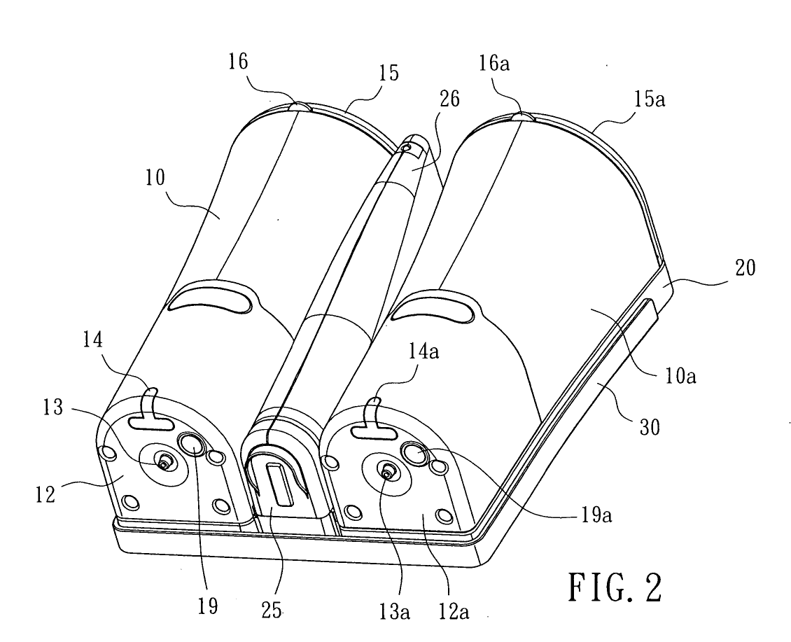

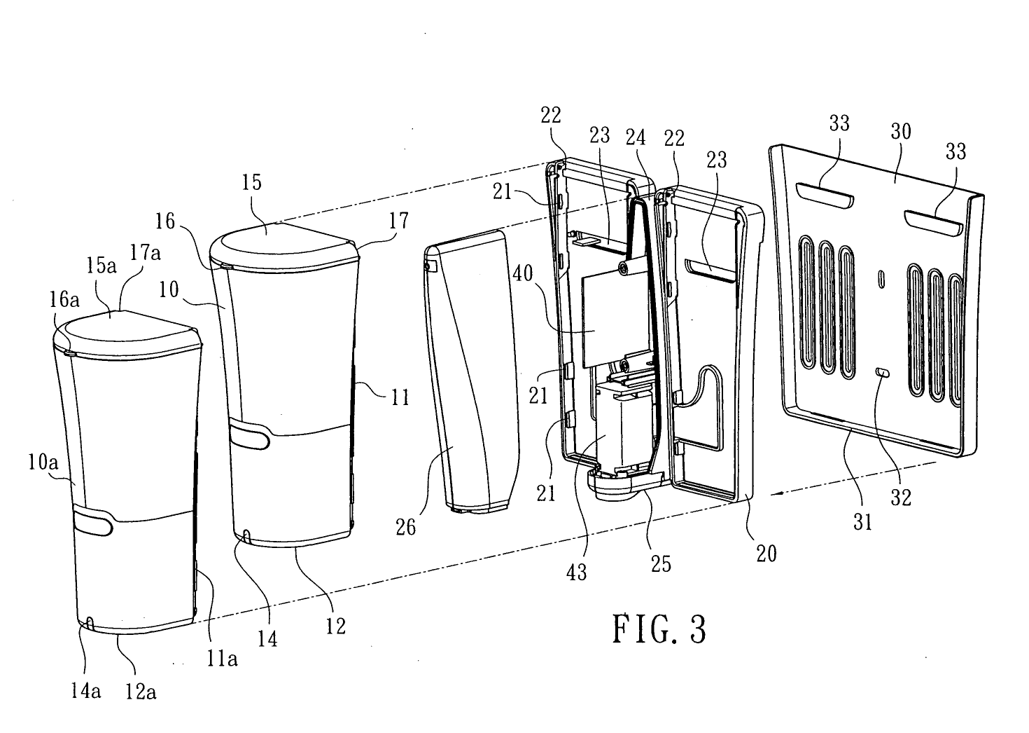

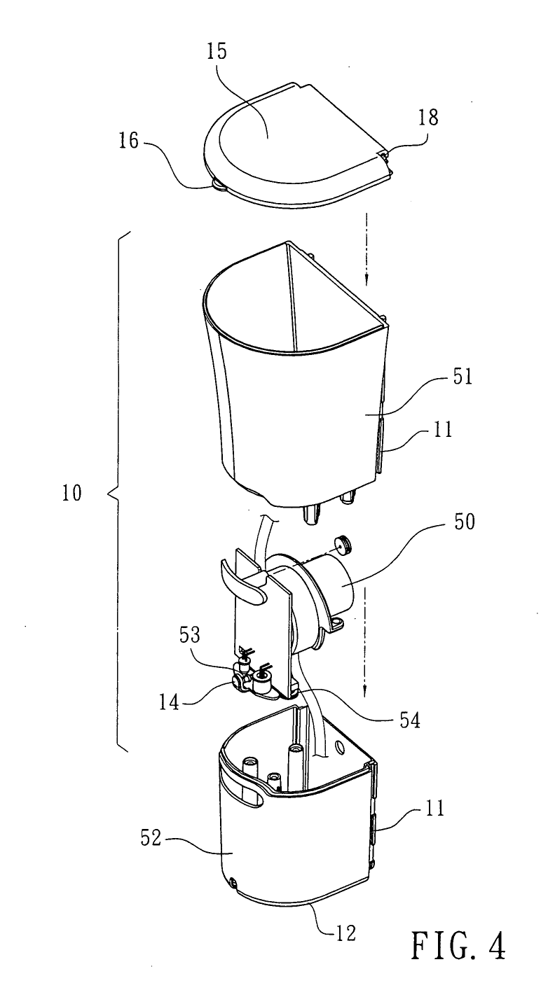

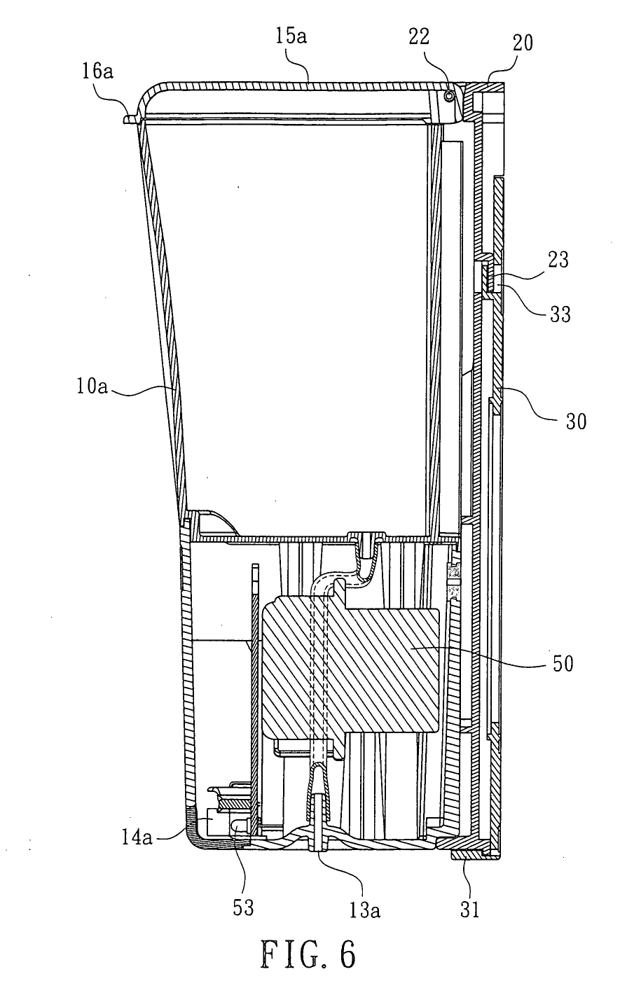

Referring to FIGS. 1 to 3, the electric multi-reservoir liquid soap dispenser comprises two reservoirs 10, 10a, a backboard 20, a central closure 26, a coupling base 30 and a control circuit 40. Couplers 11, 11a are provided on the backside of the two reservoirs 10, 10a (as shown in FIGS. 3 and 4) for inter-locking with the locking flaps 21 on the edge of the backboard 20. As such, the couplers can be designed as a locking element in form of an extruding hook so as to lock with the vertical sides of the backboard 20. The bottom of the two reservoirs 10, 10a are provided with baseboards 12, 12a, the center of which is provided with a liquid soap outlet 13, 13a, respectively (as shown in FIG. 2). Infrared ray detecting windows 19, 19a are provided adjacent to the edge of liquid soap outlets 13, 13a, while the connecting portion of the baseboards 12, 12a and the front edge of the reservoirs 10, 10a is provided with a frame, which is closed by a transparent cap 14, 14a. The top of the reservoirs 10, 10a are respectively mounted with covers 15, 15a, the rear end of which is inwardly provided with recessions 17, 17a (as shown in FIG. 3), while axle holes 18, 18a (as shown in FIGS. 4 and 6) are respectively provided on the recessions 17, 17a. The front edge of each of the covers 15, 15a is respectively provided with an extruding flap 16, 16a to ease open by a user's fingers.

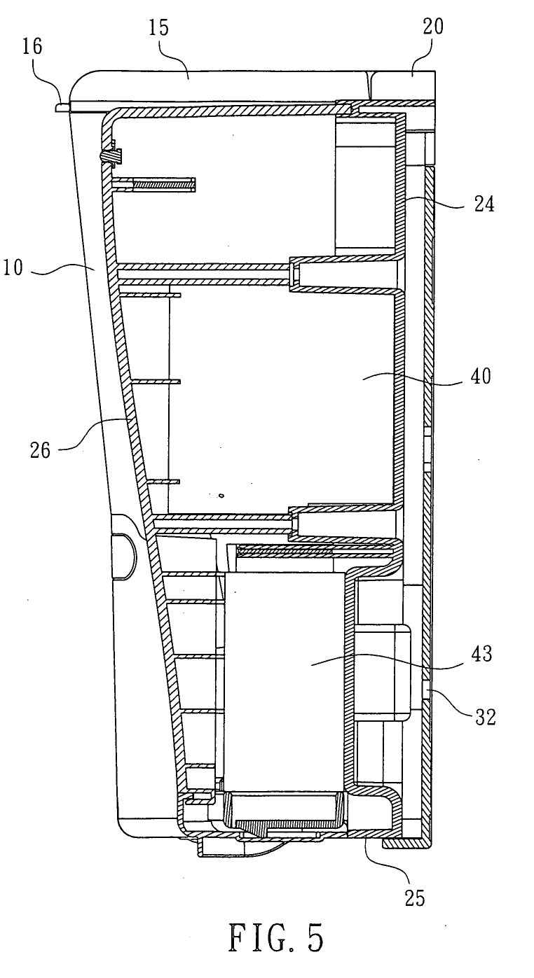

The backboard 20 is a board having a shape in adaptation to the outer line of the backside of the reservoirs 10, 10a. The backboard 20 has a connecting case 24 in the center and pluralities of locking flaps 21 on the vertical sides. An axle 22 is provided on the top of each cover 15, 15a, while back hangers 23 (as shown in FIG. 6) are extrusively provided on the backside of the backboards 20. The connecting case 24, being set in-between the reservoirs 10, 10a, has a bearing tray 25 on the bottom, pluralities of connecting bases and extrusions inside the interior for connecting with a control circuit 40 and a battery chamber 43 (as shown in FIG. 5). Meanwhile, the connecting case 24 is further mounted with a closure 26. As shown the backboard 20 is formed integrally. Whereas the above-mentioned function of holding the two reservoirs 10, 10a and the connecting case 24 can be obtained in case the backboard 20 is assembled by parts.

A coupling base 30 in the form of a board being adapted to the size of the backboard 20 is vertically provided with an extruding edge 31 at the periphery, a coupling hole 32 at the center and locking slots 33 at two sides adjacent to the top.

To assemble the invention, the extruding hooks on the couplers 11, 11a of the reservoirs 10, 10a are locked with the locking flaps 21 on the vertical sides of the backboard 20. The axle holes 18, 18a on two sides of the cover 15, 15a are coupled to the axles 22 on the top of the backboard 20, such that the covers 15, 15a can be convertibly lifted for filling the liquid soap. Further, by way of the coupling hole 32 on the connecting base 30, the coupling base 30 can be fastened with nails to an appropriate position on the wall adjacent to the washbasin. Finally, the reservoirs filled with liquid soap can be locked in the locking slots 33 of the coupling base 30 by way of back hangers 23 on the backboard 20. Accordingly, the assembly of the invention is completed.

Referring to FIG. 4, each of the reservoirs 10, 10a can be composed of a liquid soap squeezer 50, an upper reservoir 51, a lower base 52 and a cover 15. The liquid soap outlets 13, 13a on the bottom of the reservoirs can be connected to the liquid soap squeezers 50 by a hose 55, which is connected to the bottom outlet of the upper reservoir 51 at one end, and connected to the liquid soap outlets 13, 13a on the lower base 52 at the other end. The connecting portion of the baseboard 12 and the front edge of the reservoir 10 is provided with a frame, which is closed by a transparent cap 14, which is pervious to the light from an electric LED indicating light 53 provided at the front edge of the liquid squeezer 50, such that the user can recognize that the machine is in operation. An infrared ray sensor 54 is provided at the side of the liquid squeezer 50, whereas when the cover 15 provided on the top of the upper reservoir 51 can be opened for the purposes of refilling liquid soap. The periphery of the upper reservoir 51 and lower base 53 is provided with extruding hooks of the couplers 11 for connecting to the backboard 20.

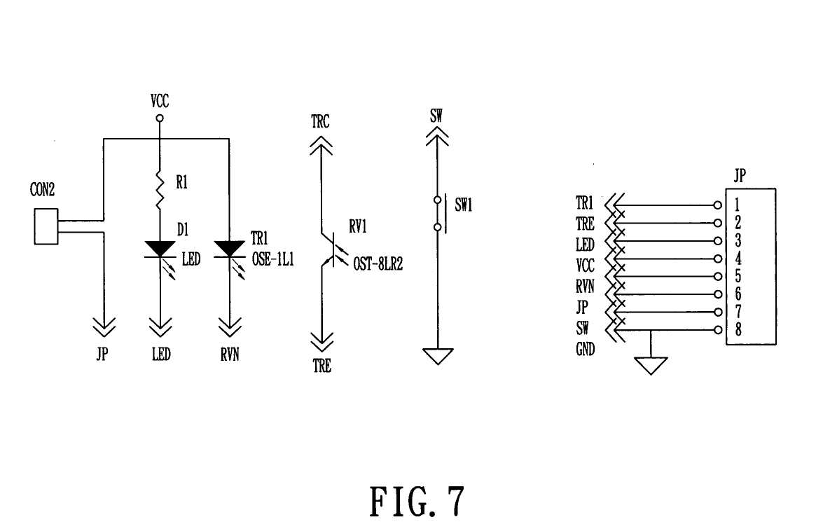

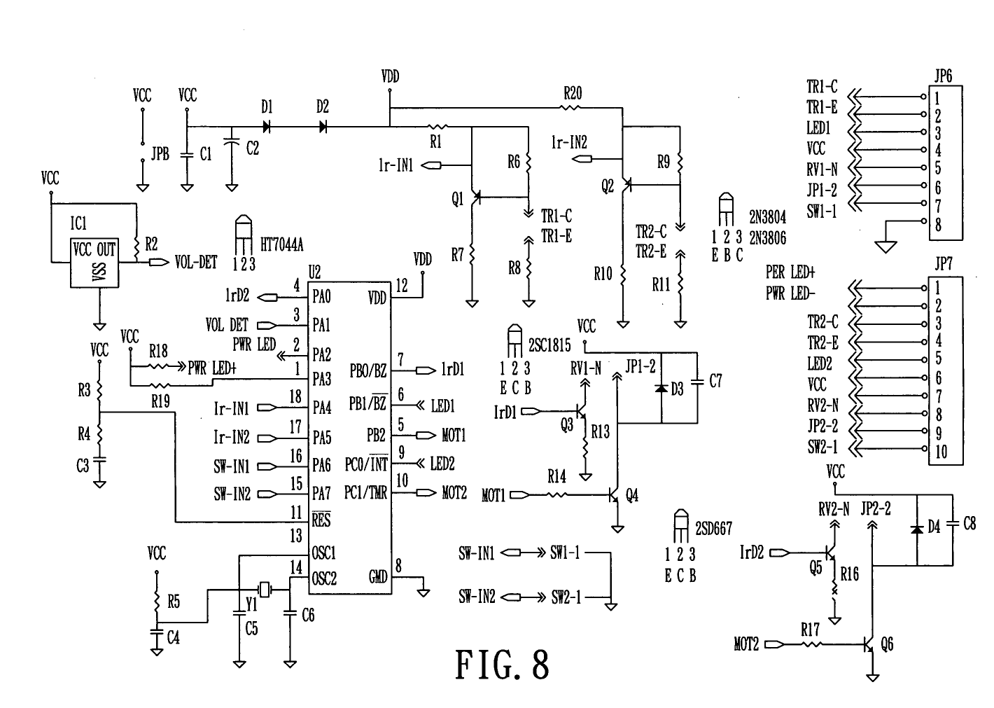

Referring to FIGS. 6, 7 and 8, an embodiment of the invention is provided with a control circuit 40, which is composed of pluralities of integrated circuits, chips, diodes, resistors, capacitors, light-emitting diodes (LED), two infrared ray sensors 54 and a battery chamber 43 (as shown in FIG. 3). The control circuit 40 is disposed in the connecting base in the middle of the connecting case 24, while the battery chamber 43 is coupled to the bearing tray 25. The control circuit 40 has the function of controlling whether or not liquid soap is squeezed out from the positions where the liquid soap outs 13, 13a on the baseboards 12, 12a of the two reservoirs 10, 10a (referring to FIG. 6). The infrared ray sensors 54 disposed inside of the infrared ray detecting windows 19, 19a of the baseboards 12, 12a of the reservoirs 10, 10a is for determining the operation of the control circuit 40, while the sensing time of the infrared ray sensors 54 should be a pre-determined parameter.

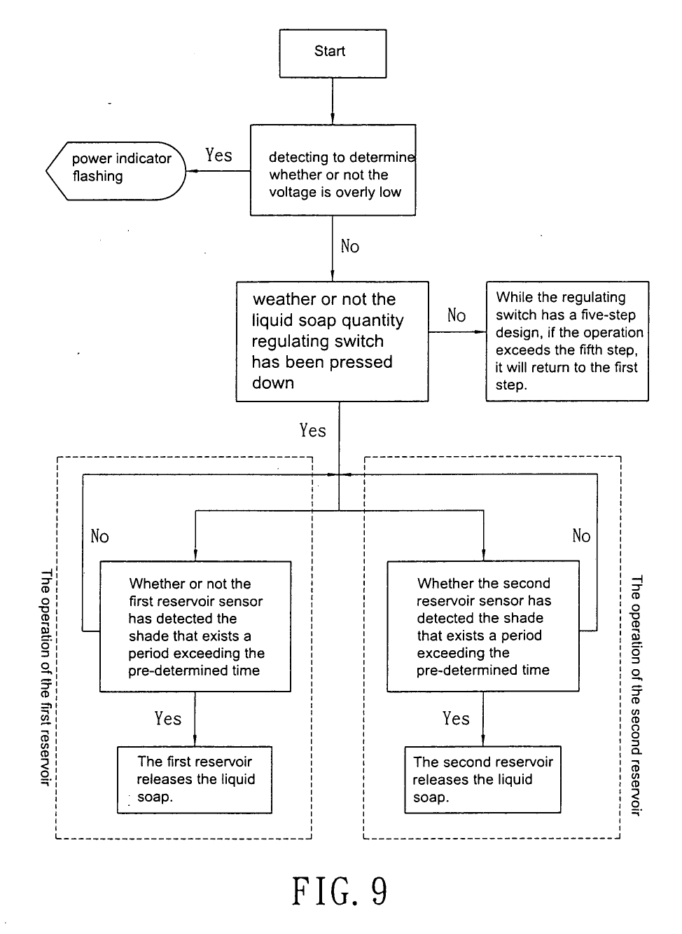

Referring to FIG. 9, when the control circuit 40 is electrified, it will firstly detect to determine whether or not the voltage is overly low. In case the voltage is overly low, the electric LED indicating light 53 will glisten to notify the user. If the voltage is normal, the control circuit 40 will further examine whether or not the liquid soap volume-regulating switch (not shown) has been pressed down (meaning the liquid soap volume is sufficient). While the regulating switch has a five-step design, if the operation exceeds the fifth step, it will return to the first step. Meanwhile, the infrared ray sensors 54 will detect the time period of being shaded, and a pre-determined quantity of liquid soap will be released from the liquid soap squeezers 50 or 50a of either of the reservoirs 10, 10a when the time that any infrared ray sensor 54 is shaded exceeds the pre-determined time.

Thereby, when the user stand in front of the washbasin with his/her hand inadvertently wave across the underside of the liquid soap dispenser, without shading the infrared ray sensor 54 for over the pre-determined time period, the control circuit 40 would not operate. Accordingly, the liquid soap would not easily release to pollute the floor or the washbasin. When the user intends to reach out for liquid soap, he/she selects either reservoir and dispose his/her hand beneath the liquid soap outlet 13, stay still for moment until the hading time of the infrared ray sensor 53 continues for a period exceeding the pre-determined time of the control circuit 40, the liquid soap squeezer 50 or 50a will proceed to operate and release an appropriate quantity of detergent from the liquid soap outlet 13 or 13a for the user's consumption.

The above descriptions are of exemplary embodiments only, and are not intended to limit the scope, applicability or configuration of the invention in any way. Rather, the following description provides a convenient illustration for implementing exemplary embodiments of the invention. Various changes to the described embodiments, such as electric three-reservoir, four-reservoir or even five-reservoir liquid soap dispenser, may be made in the function and arrangement of the elements described without departure from the scope of the invention as set forth in the appended claims.

Concluded above, the electric multi-reservoir liquid soap dispenser disclosed by the present invention can correctly select the right reservoir that is chosen by way of the control circuit no matter the number of the reservoirs is, and release an appropriate quantity of liquid soap without any error. Accordingly, the liquid soap would not pollute the environment, nor be wasted. The present invention complies with the patentabilty, and hence submitted to the Patent and Trademark Office for review and grant of the commensurate patent rights.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An electric multi-reservoir liquid soap dispenser, comprising:
at least two reservoirs, each including a containing space for containing liquid soap, the containing space has an openable cover on the top, a downward liquid outlet at the bottom, and couplers on the back of the reservoirs for coupling to the coupling base;
a control circuit, which is composed of pluralities of integrated circuits, chips, diodes, resistors, capacitors, light-emitting diodes (LED), infrared ray sensors and a voltage source (battery chamber); and
a coupling base, which is in form of a board being adopted to the shape of the backboards, such that the at least two reservoirs can be fastened thereon; coupling holes are provided on the backboards for holding the liquid soap dispenser on the wall;
by way of the detection of the control circuit, whether or not each reservoir respectively releases detergent can be correctly determined.

2. The electric multi-reservoir liquid soap dispenser according to claim 1, wherein the liquid soap outlet at the bottom of the reservoir is connected to the liquid soap squeezer by a hose.

3. The electric multi-reservoir liquid soap dispenser according to claim 1, wherein a single reservoir is composed of a liquid soap squeezer, an upper reservoir, a lower base and a cover, each liquid soap squeezer is provided with an electric light-emitting diode (LED) indicating light and a infrared ray sensor.

4. The electric multi-reservoir liquid soap dispenser according to claim 1, wherein hangers of coupler are provided around the housing of the upper reservoir and lower base for coupling to the backboard.

5. The electric multi-reservoir liquid soap dispenser according to claim 1, wherein the outer line of the backboard is a board made in adaptation to the back line of the at least two reservoirs; a connecting case is provided at the center of the backboard, which is provided with plurality of locking flaps at the vertical sides and an extruding back hanger on the back side.

6. The electric multi-reservoir liquid soap dispenser according to claim 1, wherein an axle is provided on the top of the backboard for pivotally connected to the axle hole on the cover on the top of the reservoir to ease convertibly lifting of the cover.

7. The electric multi-reservoir liquid soap dispenser according to claim 1, wherein the housing of the reservoir is provided with a window, which is covered by a transparent cap such that the electric LED indicating light provided on the liquid soap squeezer can be visible through the transparent cap to allow a user to distinguish that the dispenser is in operation.
